(19) United States
(12) Patent Application Publication
(10) Pub. No.: US 2003/0203181 A1
(43) Pub. Date: Oct. 30, 2003

(54) Interstitial material with enhanced thermal conductance for semiconductor device packaging

(75) Inventors: Michael J. Ellsworth JR., Lagrangeville, NY (US); Mark A. Marnell, Kingston, NY (US); Egidio Marotta, Poughkeepsie, NY (US); Steven J. Mazzuca, New Paltz, NY (US); Roger R. Schmidt, Poughkeepsie, NY (US)

Correspondence Address: Philmore H. Colburn II, Cantor Colburn LLP, 55 Griffin Road South, Bloomfield, CT, 06002, US

(73) Assignee: International Business Machines Corporation, Armonk, NY (US)

(21) Appl. No.: 10/134,577

(22) Filed: Apr. 29, 2002

(51) Int. Cl. B32B 3/06

(52) U.S. Cl. 428/307.3; 428/913; 428/319.1; 428/319.3

(57) ABSTRACT

A thermal interface material for conducting thermal energy between a first surface and a second surface is disclosed. In an exemplary embodiment, the thermal interface material includes a non-metallic support layer and a phase change material coated on the support layer. At a transition temperature of the phase change material, the phase change material is caused to flow into gaps present between the support layer and the first and second surfaces. In addition, phase change compound (PCC) materials may be formulated to solid phase transition over a desired temperature range, such that in a the solid phase transition mode, a structured cell/laminate may be employed as a thermal energy storage unit which can provide thermal load-damping capabilities due to its latent heat effect.

### BACKGROUND

The present invention relates generally to heat transfer materials interposable between thermal interfaces of a heat generating component and a heat dissipating component and, more particularly, to an interstitial material with enhanced thermal conductance for use in semiconductor device packaging.

The removal of heat from electronic components is a problem continuously faced by electronic packaging engineers. As electronic components have become smaller and more densely packed on integrated boards and chips, designers and manufacturers now are faced with the challenge of how to dissipate the heat generated by these components. It is well known that many electronic components, especially semiconductor components such as transistors and microprocessors, are more prone to failure or malfunction at high temperatures. Thus, the ability to dissipate heat often is a limiting factor on the performance of the component.

Electronic components within integrated circuits have been traditionally cooled via forced or natural convective circulation of air within the housing of the device. In this regard, cooling fins have been provided as an integral part of the component package or as separately attached elements thereto for increasing the surface area of the package exposed to convectively-developed air currents. Electric fans have also been employed to increase the volumetric flowrate of air circulated within the housing. For high power circuits (as well as smaller, more densely packed circuits of presently existing designs), however, simple air circulation often has been found to be insufficient to adequately cool the circuit components.

It is also well known that heat dissipation, beyond that which is attainable by simple air circulation, may be effected by the direct mounting of the electronic component to a thermal dissipation member such as a “cold-plate” or other heat sink. The heat sink may be a dedicated, thermally-conductive metal plate, or simply the chassis of the device. However, the thermal interface surfaces of an electronic component and associated heat sink are typically irregular, either on a gross or a microscopic scale. When these interfaces surfaces are mated, pockets or void spaces are developed there in-between in which air may become entrapped. These pockets reduce the overall surface area contact within the interface which, in turn, reduces the efficiency of the heat transfer therethough. Moreover, as is also well known, air is a relatively poor thermal conductor. Thus, the presence of air pockets within the interface reduces the rate of thermal transfer through the interface.

To improve the efficiency of the heat transfer through the interface, a layer of a thermally-conductive material typically is interposed between the heat sink and electronic component to fill in any surface irregularities and eliminate/reduce air pockets. Initially employed for this purpose were materials such as silicone grease or wax filled with a thermally conductive filler such as aluminum oxide. Such materials usually are semi-liquid or solid at normal room temperature, but may liquefy or become fluidic at elevated temperatures to better conform to the irregularities of the interface surfaces.

On the other hand, the greases and waxes generally are not self-supporting or otherwise form stable at room temperature and are considered to be messy to apply to the interface surface of the heat sink or electronic component. To a large extent, elastomeric and phase change materials (PCM) have replaced mica pads and thermal greases as a means for enhancing the heat transfer across a material junction/joint. Elastomeric gaskets of high thermal conductivity are often used as interface materials between the electronic component and the heat spreader or heat sink. However, when solid interstitial materials are used, such as thermal compounds, elastomers or adhesive tapes, the joint conductance problem becomes much more complicated since these materials introduce an additional interface to the problem.

### BRIEF SUMMARY

The foregoing discussed drawbacks and deficiencies of the prior art are overcome or alleviated by a thermal interface material for conducting thermal energy between a first surface and a second surface. In an exemplary embodiment, the thermal interface material includes a non-metallic support layer and a phase change material coated on the support layer. At a transition temperature of the phase change material, the phase change material is caused to flow into gaps present between the support layer and the first and second surfaces.

In another embodiment, the support layer is a graphite laminate layer having a thermal conductivity of at least 7.0 W/m-K, and the phase change material is metallic tin.

### BRIEF DESCRIPTION OF THE DRAWINGS

Referring to the exemplary drawings wherein like elements are numbered alike in the several Figures:

FIG. 1(a) is an exemplary model of thermal conductance across an interface between a pair of components such as a heat generating electronic component and a heat dissipation component;

FIG. 1(b) depicts an equivalent thermal resistance circuit for the thermal interface of FIG. 1(a);

FIG. 2 is an exploded, elevational view of a semiconductor packaging assembly featuring an interstitial, thermal interface material in accordance with the present invention embodiments; and

FIG. 3 is cross-sectional view of an exemplary interface between a first contacting surface and a second contacting surface, along with interstitial material disposed therebetween.

### DETAILED DESCRIPTION

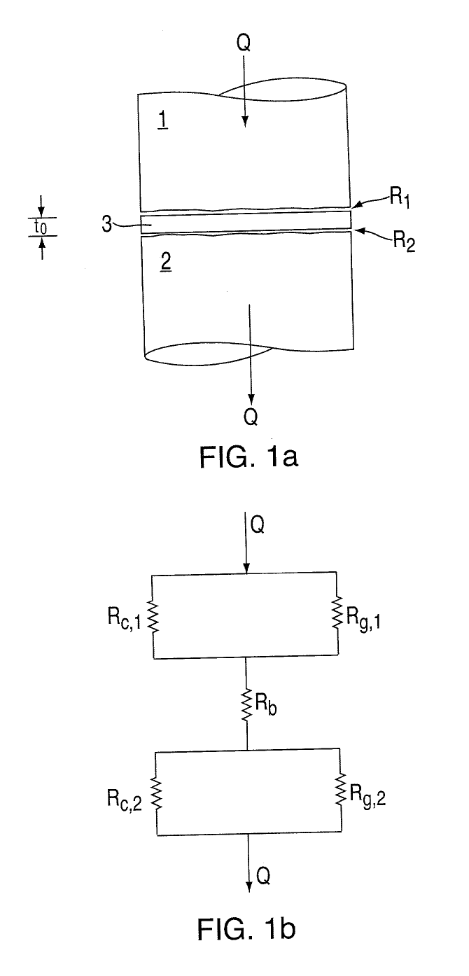

Referring initially to FIG. 1(a), there is illustrated an exemplary model of thermal conductance across an interface between a pair of components 1, 2 (such as an electronic component and a heat dissipation component) with an existing interstitial material 3 (e.g., a polymer layer) disposed therebetween. As can be seen, the flow of thermal energy (Q) from one component to the other is not only affected by the bulk thermal resistance of the interstitial material 3, but also by the thermal resistance of the interface between component 1 and interstitial material 3 (referred to hereinafter as interface 1), in addition to the thermal resistance of the interface between component 2 and interstitial material 3 (referred to hereinafter as interface 2).

FIG. 1(b) depicts an equivalent thermal resistance circuit for the thermal interface of FIG. 1(a). The thermal resistance of interface 1 includes the resistance of the actual micro contacts between the component 1 and interstitial material 3 (designated R_{c,1}), as well as the resistance of the gaps present therebetween (designated R_{g,1}). Likewise, the thermal resistance of interface 2 includes the resistance of the micro contacts between component 2 and interstitial material 3 (designated R_{c,2}), as well as the resistance of the gaps present therebetween (designated R_{g,2}). Accordingly, the joint resistance to heat flow that also incorporates the bulk properties of the polymer interstitial layer 3 may be defined as:

Rⱼ=R_{interface 1}+R_{bulk}+R_{interface 2}

where R_{interface} is the thermal resistance at the respective interfaces, and R_{bulk} is the thermal resistance due to the bulk properties of the bulk material. Since R_{interface 1} is the parallel combination of R_{c,1} and R_{g,1}, and since R_{interface 2} is the parallel combination of R_{c,2} and R_{g,2}, the joint resistance equation becomes:

$${R}_{j} = \frac{1}{\frac{1}{{R}_{c , 1}} + \frac{1}{{R}_{g , 1}}} + {R}_{bulk} + \frac{1}{\frac{1}{{R}_{c , 2}} + \frac{1}{{R}_{g , 2}}}$$

This resistance equation can also be rewritten in terms of thermal conductance for both the interface and bulk conductance, therefore a final joint conductance expression is written as:

$${h}_{j} = \frac{1}{\frac{1}{{h}_{interface , 1}} + \frac{{t}_{0} ( 1 - \frac{P}{{E}_{layer}} )}{{k}_{layer}} + \frac{1}{{h}_{interface , 2}}}$$

where t₀ is the original thickness of the bulk interstitial material 3 at no load, P is the applied pressure to the interstitial material 3, E_{layer} is the Young's modulus (i.e., strength) of the interstitial material 3, and k_{layer} is the thermal conductivity of the interstitial material 3.

The aforementioned model may be employed to calculate the joint resistance (or conductance) for an interface formed, for example, between a heat sink and cap or heat spreader with an interstitial material introduced to enhance heat transfer across the junction. As the model also indicates, when the bulk material thickness becomes very thin or very compliant (i.e., the value of E_{layer} is low), and if the bulk thermal conductivity is high, then the interface conductance (in this case the contact and gap conductance) at each interface will dominate the overall joint thermal resistance. Thus, the joint conductance expression reduces to:

$${h}_{j} = \frac{1}{\frac{1}{( {h}_{micro , 1} + {h}_{gap , 1} )} + \frac{1}{( {h}_{mivro , 2} + {h}_{gap , 2} )}}$$

As will be appreciated from the above expression, an effective interstitial material between a heat generating component and a heat dissipating component will provide a relatively high thermal conductance for both the micro contacts and the gaps at both interfaces.

Therefore, in accordance with an embodiment of the invention, there is disclosed an interstitial material with enhanced thermal conductance, which may be used in semiconductor cooling and packaging applications. Briefly stated, the interstitial material includes a soft, thin, and accommodating non-metallic support layer (preferably a carbon graphite support layer having an E_{layer} of approximately 40 MPa or less), with a thermal conductivity value greater than 7.0 W/m-K, in combination with a high temperature phase change compound (PCC) (e.g., having a transition temperature greater than 60° C.), preferably comprising a soft, metallic layer such as tin (Sn) coated onto each side of the contacting interfaces. This composite interstitial material configuration helps to enhance the gap conductance (i.e., minimize the gap resistance). Furthermore, since the support layer is compliant due to its low Young's modulus, the contact or microscopic resistance between the interfaces is significantly reduced. Accordingly, the mechanical and thermophysical properties, as well as the geometric surface parameters of the contacting surfaces, will all play a role in improving the thermal joint conductance between metallic or nonmetallic junctions.

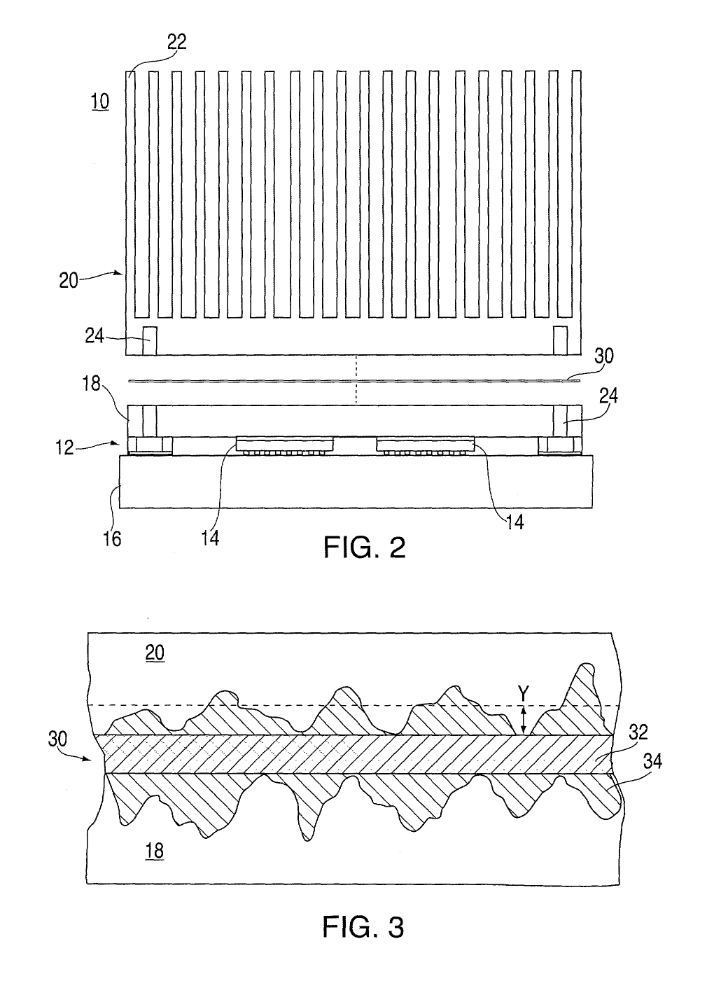

Referring now to FIG. 2, there is shown an exploded, elevational view of a semiconductor packaging assembly 10 in which the interstitial, thermal interface material of the present invention embodiments may be utilized. As shown in FIG. 2, assembly 10 generally includes a multichip module (MCM) 12 having a plurality of individual semiconductor chips 14 attached to a common substrate 16. In addition, a heat spreader 18 is in thermal contact with both the substrate 16 and the chips 14 to facilitate a more even distribution of the heat generated by the chips 14 and the substrate 16. The heat collected and spread throughout heat spreader 18 is then dissipated by means of heat sink 20, through individual cooling fins 22 that are exposed to the ambient. The heat sink 20 is mechanically secured to the heat spreader 18 through conventional means, such as by screws (not shown) that are inserted through threaded openings 24 in the heat sink 20 and the heat spreader 18.

FIG. 2 further illustrates the interstitial material 30 of the present invention embodiments placed between: (1) the interface of the heat spreader 18 and the heat sink 20; (2) the interfaces of the individual chips 14 and the heat spreader 18; and (3) the interfaces between the substrate 16 and the heat spreader 18. Although the thermally conductive interstitial material 30 is illustrated in the context of a semiconductor packaging cooling application, it will be appreciated that the interstitial material 30 may be used in other applications where, generally, a heat generating component is thermally joined with a heat spreading or heat dissipating component.

FIG. 3 is cross-sectional view of an exemplary interface between a first contacting surface (such as, for example, the heat sink 20) and a second contacting surface (such as, for example, the heat spreader 18), along with interstitial material 30 disposed therebetween. As stated earlier, the interstitial material 30 includes a carbon graphite support layer 32 coated with a phase change material 34 having a preferred transition temperature from about 83° C. to about 140° C. In a preferred embodiment, the support layer 32 is a graphite laminate material made by Graftech, Inc. and marketed under the trademark eGraf™.

The phase change material 34 may include high temperature phase change compounds (PCC) that may be formulated from a single component or from multiple components (e.g., a binary mixture formulation). One specific example of a suitable high-temperature, single component PCC is C-ring paraffin wax currently used for hermetic sealing of IBM MCM modules for Freeway systems (zSeries eServers). An exemplary high-temperature, multiple component PCC is a binary mixture of polyalcohols pentaglycerine (PC) and neopentylglycol (NPG). The binary PC/NPG mixture has shown promise in electronic applications due to its high latent heat over an appropriate temperature range, as well as solid state phase transition which results in a “dry” process and a low cost. Furthermore, such PCC materials may be formulated to solid phase transition (e.g., tetragonal to cubic plastic phase) over the temperature range of about 24° C. to about 83° C., or a solid to liquid phase transition from about 138° C. to about 200° C. if so desired.

In the solid phase transition mode, a structured cell made from the PC/NPG composite material may be employed as a thermal energy storage unit which can provide thermal load-damping capabilities due to its latent heat effect. On the other hand, for the solid to liquid transition mode, these compounds can be used to enhance the thermal gap conductance for contacting surfaces. Different molar percent combinations (mol % NPG into PG) may also be formulated to fine tune the solidus or melting temperature to desired values. If lower solid to liquid transition temperatures are desired (e.g., less than 138° C.), then the same may be achieved by using the paraffin wax employed in IBM sealing technology, or through varying molar percent combinations of either PC or NPG compounds.

Notwithstanding the above described examples, a preferred choice for the phase change material 34 is the use of metallic tin (Sn) as the coating compound on the graphite layer 32. Metallic tin provides a significantly higher thermal performance over other conventional phase change materials due to its low hardness (having a comparable hardness to the graphite support layer 32), and a high thermal conductivity (k=66.8 W/m-K). Such thermophysical and mechanical properties are especially desirable for enhancing both the thermal contact conductance (asperity contact) and the gap thermal conductance (voids caused by the machining or surface finishing process which are filled by the soft metal).

Referring once again to FIG. 3, the significance of having a high thermal conductivity phase change material will be appreciated. As is shown, a microscopic view of the interface area between the first and second contacting surfaces reveals the surface irregularities of both surfaces. The dashed line shown through each contacting surface represents a reference mean plane with respect to the opposing surface of the graphite layer 32. The distance “Y” therefore represents the effective or average gap between the contacting surfaces and the graphite layer 32. The greater the value of Y, the larger the amount of gap volume between the contacting surfaces and the graphite layer 32. Thus, the combination of using a relatively soft, compliant support layer 32, such as graphite, with a soft metal for the phase change material 34, elevated temperatures cause the metal to reflow and fill the gaps with high thermal conductivity material. This causes the distance Y to be minimized, resulting in greater thermal interface performance.

Finally, it should be noted that in addition to tin, other soft metals may be used for the phase change material 34. For example, lead, indium and silver (as well as mixtures thereof) are also relatively soft metals having high thermal conductivity, with values generally exceeding 1 W/m-K. The metal may be deposited upon the graphite layer 32 by methods such as chemical vapor deposition (CVD) or by physical vapor deposition (PVD), to a preferred thickness of about 1 to about 10 microns (μm). More preferably, the thickness of the phase change material 34 is in the submicron range.

Through the use of the above described interstitial material 30, certain process criterial for specific applications such as a high temperature bum-in processes for early failures in MCM devices may be met. By using a soft, compliant support structure (which allows maximum asperity contact area at low interface pressure thus minimizing the microscopic contact resistance) in combination with a soft, metallic phase change material (PCM), a significant improvement in thermal conductance is achieved over existing thermal interface technologies that employ either an aluminum support structure (i.e., high hardness values) or low thermal conductivity polymide polymers (i.e., thermal conductivity values less than 1 W/m-K).

While the invention has been described with reference to a preferred embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A thermal interface material for conducting thermal energy between a first surface and a second surface, comprising:
a non-metallic support layer; and
a phase change material coated on said support layer;
wherein, at a transition temperature of said phase change material, said phase change material is caused to flow into gaps present between said support layer and the first and second surfaces.

2. The thermal interface material of claim 1, wherein said support layer comprises a graphite laminate layer.

3. The thermal interface material of claim 2, wherein said support layer has a thermal conductivity of at least 7.0 W/m-K.

4. The thermal interface material of claim 1, wherein said phase change material comprises paraffin wax.

5. The thermal interface material of claim 1, wherein said phase change material comprises a binary mixture of polyalcohols pentaglycerine (PC) and neopentylglycol (NPG).

6. The thermal interface material of claim 1, wherein said phase change material is metallic.

7. The thermal interface material of claim 6, wherein said phase change material has a thermal conductivity of at least 1.0 W/m-K.

8. The thermal interface material of claim 6, wherein said phase change material is selected from the group consisting of: tin, lead, indium, silver and mixtures thereof.

9. The thermal interface material of claim 6, wherein said phase change material has a thickness of less than 10 microns.

10. The thermal interface material of claim 1, wherein:
said support layer comprises a graphite laminate layer having a thermal conductivity of at least 7.0 W/m-K; and
said phase change material comprises metallic tin.

11. A thermal interface material for use in the cooling of a semiconductor package, comprising:
a non-metallic support layer disposed between a heat generating component and a heat dissipating component; and
a phase change material coated on said support layer;
wherein, at a transition temperature of said phase change material, said phase change material is caused to flow into gaps present between said support layer and said heat generating component, and into gaps present between said support layer and said heat dissipating component.

12. The thermal interface material of claim 11, wherein said support layer comprises a graphite laminate layer.

13. The thermal interface material of claim 12, wherein said support layer has a thermal conductivity of at least 7.0 W/m-K.

14. The thermal interface material of claim 11, wherein said phase change material comprises paraffin wax.

15. The thermal interface material of claim 11, wherein said phase change material comprises a binary mixture of polyalcohols pentaglycerine (PC) and neopentylglycol (NPG).

16. The thermal interface material of claim 11, wherein said phase change material is metallic.

17. The thermal interface material of claim 16, wherein said phase change material has a thermal conductivity of at least 1.0 W/m-K.

18. The thermal interface material of claim 16, wherein said phase change material is selected from the group consisting of tin, lead, indium, silver and mixtures thereof.

19. The thermal interface material of claim 16, wherein said phase change material has a thickness of less than 10 microns.

20. The thermal interface material of claim 11, wherein:
said support layer comprises a graphite laminate layer having a thermal conductivity of at least 7.0 W/m-K; and
said phase change material comprises metallic tin.

21. A method for facilitating the transfer of thermal energy between a first surface and a second surface, the method comprising:
disposing a non-metallic support layer between the first surface and the second surface; and
coating a phase change material on said support layer;
wherein, at a transition temperature of said phase change material, said phase change material is caused to flow into gaps present between said support layer and the first and second surfaces.

22. The method of claim 21, wherein said support layer comprises a graphite laminate layer.

23. The method of claim 22, wherein said support layer has a thermal conductivity of at least 7.0 W/m-K.

24. The method of claim 21, wherein said phase change material comprises paraffin wax.

25. The method of claim 21, wherein said phase change material comprises a binary mixture of polyalcohols pentaglycerine (PC) and neopentylglycol (NPG).

26. The method of claim 21, wherein said phase change material is metallic.

27. The method of claim 26, wherein said phase change material has a thermal conductivity of at least 1.0 W/m-K.

28. The method of claim 26, wherein said phase change material is selected from the group consisting of: tin, lead, indium, silver and mixtures thereof.

29. The method of claim 26, wherein said phase change material has a thickness of less than 10 microns.

30. The method of claim 21, wherein:
said support layer comprises a graphite laminate layer having a thermal conductivity of at least 7.0 W/m-K; and
said phase change material comprises metallic tin.
